(19) United States
(12) Patent Application Publication
(10) Pub. No.: US 2015/0293336 A1
(43) Pub. Date: Oct. 15, 2015

(54) Spatial Filter Enhanced Spinning Disk Confocal Microscope

(71) Applicants: Adam E. COHEN, (US); Jennifer H. HOU, (US); President and Fellows of Harvard College, Cambridge, MA (US)

(72) Inventors: Adam E. Cohen, Cambridge, MA (US); Jennifer H. Hou, Cambridge, MA (US)

(21) Appl. No.: 14/439,761

(22) PCT Filed: Oct. 30, 2013
(86) PCT No.: PCT/US2013/067543

§ 371 Date: Apr. 30, 2015

Related U.S. Application Data
(60) Provisional application No. 61/720,239, filed on Oct. 30, 2012.

(51) Int. Cl. G02B 21/00

(52) U.S. Cl. CPC G02B 21/0044; G02B 21/0076

(57) ABSTRACT

A spatial filter includes a first focal plane to receive sample fluorescence and auto-fluorescence from a microscope, a first lens to receive the sample fluorescence and auto-fluorescence and focus rays of the sample fluorescence, a mask aperture positioned in a plane where sample fluorescence rays maximally converge, the mask aperture positioned where such rays converge to pass the rays, the aperture having a size that is a function of characteristics of the microscope, and a second lens positioned to receive the passed rays from the spatial filter and form images at a second focal plane to couple to a camera.

### CLAIM OF PRIORITY

Benefit of priority is hereby claimed to U.S. Provisional Patent Application Ser. No. 61/720,239, filed Oct. 30, 2012, which is hereby incorporated by reference in its entirety.

### GOVERNMENT FUNDING

This invention was made with Government support under N00014-09-1-0868 awarded by the Office of Naval Research. The Government has certain rights in the invention.

### BACKGROUND

Spinning disk confocal microscope systems are a standard tool in imaging centers and biology labs around the world. Many spinning disk microscope systems may be only useful for brightly fluorescent samples because of poor sensitivity and high background levels.

### SUMMARY

A spatial filter includes a first focal plane to receive sample fluorescence and auto-fluorescence from a microscope, a first lens to receive the sample fluorescence and auto-fluorescence and focus rays of the sample fluorescence, a circular aperture positioned in a plane where sample fluorescence rays converge, positioned to pass the rays, the aperture having a size that is a function of characteristics of the microscope, and a second lens positioned to receive the passed rays from the aperture and form images at a second focal plane to couple to a camera.

A method includes receiving rays of sample fluorescence and auto-fluorescence from a microscope providing the sample fluorescence at a first focal plane, focusing the received rays of sample fluorescence, passing the rays of sample fluorescence through a circular aperture having a diameter adapted to pass the rays of sample fluorescence at a point where the rays converge, and receiving the passed rays from the spatial filter and forming images at a second focal plane.

### BRIEF DESCRIPTION OF THE DRAWINGS

FIG. 1 is a block diagram of a spinning disk microscope system with a spatial filter according to an example embodiment.

FIG. 2 is a block diagram illustrating illumination and sample fluorescence paths through a system with a spatial filter according to an example embodiment.

FIG. 3 illustrates contrasting photographs of samples using a spinning disk microscope with and without a spatial filter according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that structural, logical and optical changes may be made. The following description of example embodiments is, therefore, not to be taken in a limited sense, and the scope is defined by the appended claims.

Spinning disk confocal microscopy is a technique for imaging fluorescence from a single plane in a three-dimensional sample. The essence of the technique is to scan a large number of tightly focused illumination spots across a sample. These focal spots are imaged onto an array of pinholes which passes fluorescence from the focal spots while rejecting out-of-focus fluorescence from the sample. Existing spinning disk confocal microscopes suffer from a high background due to autofluorescence from a dichroic mirror as well as other components inside the spinning disk unit itself The autofluorescence of these components is not blocked by the array of pinholes. The addition of a spatial filter device interposed between the spinning disk unit and a camera improves performance of a microscope system. The spatial filter blocks the majority of autofluorescence generated inside the spinning disk unit, while passing a fluorescence signal emitted from a sample. This system significantly improves the signal-to-background ratio, and enables optical imaging of samples that were previously too dim to observe.

A previously unknown defect in the design of spinning disk confocal microscopy systems involves illumination light that passes through a dichroic mirror, and in the process generates a significant amount of autofluorescence which reaches a detector. The addition of a spatial filter element significantly improves the signal-to-background ratio up to 37-fold in some embodiments. The use of the filter may dramatically increase the range of applications of these spinning disk systems.

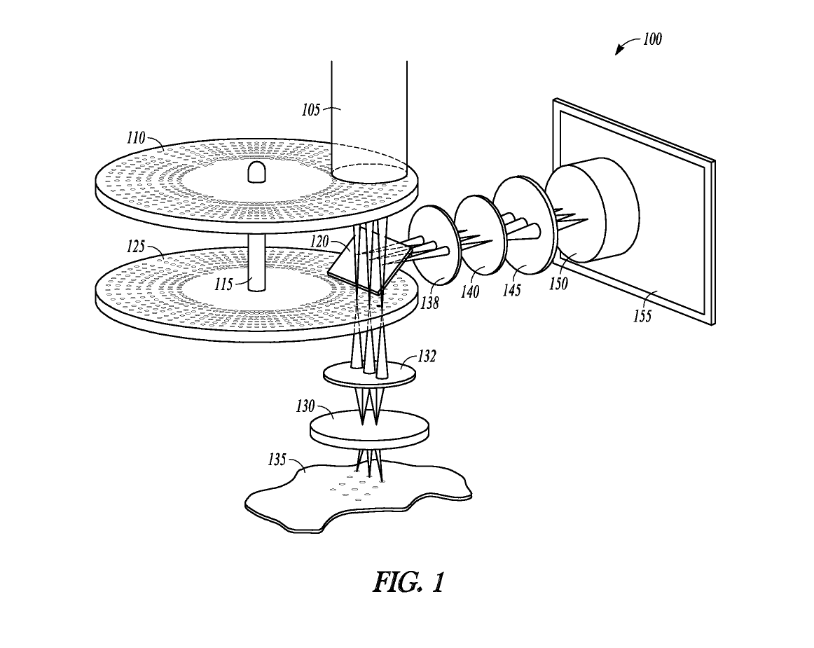

A spinning disk system 100 is illustrated in block form in FIG. 1. Several lenses are omitted from the figure for simplicity. On an illumination side, a shaped and collimated laser beam 105 is provided, to a microlens array disk 110 mounted on an axle 115. A dichroic mirror 120 receives illumination through the microlens array disk 110 and passes it to a pinhole disk 125, also mounted on the axle 115. The pinhole disk 125 rotates with the microlens array disk 110 and passes the illumination via a tube lens 132, followed by an objective lens 130 to a specimen or sample 135.

Fluorescence from the specimen is received by the objective lens 130 and is directed by a tube lens 132 through the pinhole disk 125. Tube lens 132 operates to refocus the fluorescence from the specimen at the pinholes. The dichroic mirror 120 reflects the fluorescence through a lens 138, a barrier filter 140, and a lens 145 to spatial filter 150. Barrier filter 140 operates to reject excitation wavelengths, while passing specimen fluorescence wavelengths. Lens 138 and Lens 145 operate to focus the fluorescence from each pinhole to a plane where a camera would normally be placed.

The spatial filter 150 blocks a significant amount of unfocused autofluorescence of the dichroic mirror 120, while passing the focused specimen fluorescence. The two lenses 138 and 145 are used to re-image the pinhole array 125 via the spatial filter 150 onto an electronic camera 155.

In one embodiment, the micro-lens array disk 110 is formed as an array of confocal pinholes and rotates about axle 115. The pinhole disk 125 rotates on the same axle 115 and is comprised of an array of pinholes arranged so illumination from each micro-lens of the micro-lens array disk 110 is focused on one pinhole. The dichroic mirror 120 is placed at an angle, typically 45°, between the micro-lens array disk 110 and the pinhole array disk 125. The disks are arranged relative to an optical microscope such that the pinhole array is in an image plane of the microscope.

The axle 115 containing the microlens and pinhole array disks is typically set to rotate at a high speed, typically 1,800-10,000 rpm. Collimated illumination 105 impinges on the microlens array 110, passes through the dichroic mirror 120, and passes through the pinholes 125. The microscope then projects a demagnified image of the pinhole array onto a focal plane inside the specimen sample 135. The focal spots excite fluorescence from the sample. The objective lens captures the fluorescence and the microscope re-images the fluorescence onto the pinhole array. Fluorescence emanating from the focal plane is brought to sharp focus on the pinholes and passes with high efficiency. Out of focus fluorescence is largely blocked by the pinholes.

The fluorescence then reflects off the dichroic mirror. A lens or set of lenses re-images the pinhole array onto a camera, often a CCD or EMCCD camera. The rotation rate of the pinhole array is sufficiently fast compared to the frame rate of the camera that the camera registers a seemingly continuous image of the focal plane.

In principle, spinning disk confocal microscopy enables highly sensitive and depth-resolved fluorescence imaging. However, existing systems suffer from a background signal due to weak autofluorescence of the dichroic. This background interferes with imaging of very dim samples, such as single fluorescent molecules or very dim fluorophores.

The autofluorescence of the dichroic is a more severe problem in spinning disk confocal microscopy than in conventional epifluorescence microscopy for two reasons. In spinning disk systems, the excitation light passes through the entire thickness of the dichroic, while in epifluorescence systems, the intense excitation light reflects off the front surface of the dichroic. Thus the excitation light in spinning disk systems interacts with a far larger volume of the dichroic (the entire thickness) than in epifluorescence (just the front surface). The excitation light therefore excites far more fluorescence from the substrate of the dichroic in spinning disk systems.

In epifluorescence systems, the dichroic mirror is far from an image plane. Only a small fraction of non-collimated light emitted from the dichroic is collected by the microscope optics and re-imaged onto the detector. In spinning disk systems, the dichroic is positioned close to an image plane. The optics 138, 140, 145 that re-image the pinholes onto the camera also collect a large fraction of the autofluorescence of the dichroic.

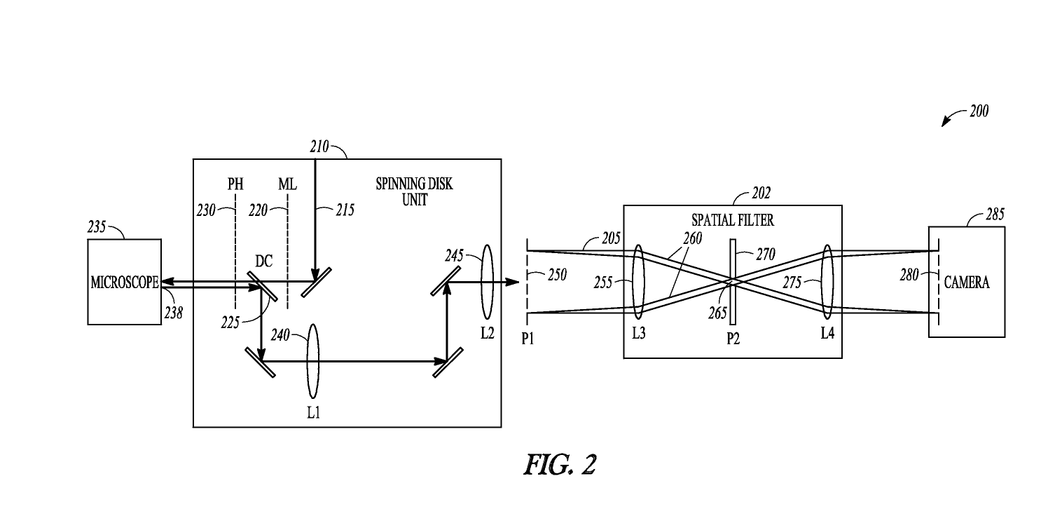

FIG. 2 is a block diagram of a microscope system 200 that includes a spatial filter unit 202 positioned to pass a signal 205 from a pinhole array while blocking autofluorescence from a dichroic. Inside a spinning disk unit 210, excitation light 215 passes through a microlens array (ML) 220, through a dichroic mirror (DC) 225, through a pinhole array (PH) 230 and to a microscope 235. Fluorescence 238 from a sample via the microscope 235, passes through PH 230 and then reflects off DC 225.

Lenses L1 240 and L2 245 project a real image of the pinhole array 230 at intermediate image plane, P1 250. Traditionally a camera would reside at P1 250. The numerical aperture of the desired signal at P1 is given by NA/M, where NA is the numerical aperture of the objective and M is the magnification. In contrast, the numerical aperture of the autofluorescence at P1 250 is D2/(2×f2), where D2 is the diameter of L2 245 and f2 is its focal length.

A lens L3 255 with focal length f3 is focused on P1, collimating the rays 205 emerging from each pinhole into a bundle 260 of diameter D3=2 f3×NA/M. Lens L3 255 refracts or focuses the rays from each pinhole such that a centerline of the rays from each pinhole passes through the focal point at plane P2 265, a distance f3 away from L3 260. At the focal point, the bundles of rays cross. A circular aperture 265 of diameter D3 in a mask 270 passes the light from the spinning disk pinholes. The diameter of the aperture 265 is thus selected as a function of characteristics of the microscope. In one embodiment, the diameter is selected based on the diameter of the bundle of rays emerging from each pinhole of the spinning disk. In contrast, the autofluorescence of the dichroic 225 is not confined at plane P2 270 and is mostly blocked by the circular aperture 265.

A lens L4 275 is focused on a plane P3 280 and forms an image at P3 280, where a camera 285 is placed.

Thus, a spatial filter that includes L3 255, mask 270, and L4 275 is interposed between a microscope and a camera. It receives fluorescence from the sample via the pinholes, as well as autofluorescence from the microscope, and effectively filters out much of the autofluorescence, allowing the sample fluorescence to be more easily detected. The autofluorescence is dispersed when it reaches the spatial filter since it is not constrained by the pinholes. In other words, the autofluorescence has a broader angular distribution than the sample fluorescence at the first focal plane, and hence is not focused through the circular aperture 265. The remainder of the mask 270 blocks the autofluorescence. Lower levels of sample fluorescence may be detected using the microscope and camera, with the spatial filter adapted to be interposed between the microscope and camera.

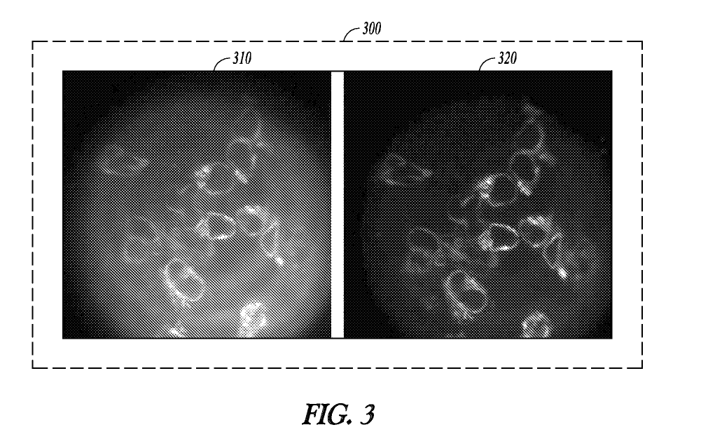

FIG. 3 at 300 illustrates selected photographs of samples using a spinning disk microscope without a spatial filter at 305 and with a spatial filter at 310. Photographs 305 and 310 show the effect of the spatial filter on an image of HEK293 cells expressing an archaerhodopsin-based near infrared fluorescent protein. The illumination is somewhat nonuniform because an input fiber and beam-shaping optics were bypassed to maximize the illumination intensity at the sample. The background signal was verified as being due to autofluorescence, rather than due to leakage through the filters: inclusion of additional excitation filters (600 nm short-pass) and additional emission filters (640 nm long-pass) had only a minor effect on the background level. The photographs are typical of results that may be obtained with the use of a spatial filter. Varying parameters, such as focal lengths of the lenses in the spatial filter, as well as the beam shaping optics for the excitation light may result in better or worse results.

In one embodiment, the sample consisted of HEK cells expressing an Archaerhodopsin-based fluorescent protein. Excitation was at 594 nm, 18 mW at the sample; the objective lens was a 60× NA 1.2 water immersion objective. Fluorescence emission was collected between 610-750 nm. Detection was on an Andor DU-897 EMCCD, with electron-multiplying gain of 300.

The spatial filter can be applied in fluorescence microscopy to reject background autofluorescence from sources other than the dichroic. For instance, in fluorescence microscopy with ultraviolet excitation, there is often significant autofluorescence from the objective itself The spatial filter may be used to reject this background, either in the context of spinning disk confocal microscopy, or in the context of conventional epifluorescence microscopy.

In further embodiments, the lenses on the detection path, L3 and L4, may be adjusted to vary the magnification of the image to accommodate detectors of different active areas. The pinhole P2 265 may be replaced with an iris of variable diameter to enable optimization of the background rejection.

In one embodiment, all the lenses are achromatic doublets. However, other lenses can be selected to minimize spherical aberrations.

### EXAMPLES

1. A spatial filter comprising:
a first focal plane to receive sample fluorescence and auto-fluorescence from a system providing the sample fluorescence;
a first lens to receive the sample fluorescence and auto-fluorescence and collimate the sample fluorescence;
a spatial filter positioned in a plane where collimated sample fluorescence rays converge, the spatial filter having an opening where such rays converge to pass the rays; and
a second lens positioned to receive the passed rays from the spatial filter and form images at a second focal plane to couple to a camera.

2. The filter of example 1 wherein the opening is a pinhole having a diameter corresponding to a diameter of a bundle of the collimated rays.

3. The filter of any of examples 1-2 wherein the opening is an adjustable iris, adjustable to a diameter corresponding to a diameter of a bundle of the collimated rays.

4. The filter of any of examples 1-3 wherein the first focal plane receives an image of a fluorescing sample, wherein rays of the image are collimated by the first lens to diameter D3, wherein the opening in the spatial filter has a diameter of approximately D3, and wherein the autofluorescence is dispersed at the first focal plane.

5. The filter of any of examples 1-4 wherein the received autofluorescence is generated by a dichroic mirror and wherein the sample fluorescence is received through a rotating pinhole array.

6. The filter of any of examples 1-5 wherein the sample fluorescence and autofluorescence are provided by a spinning disk confocal microscopy unit, and wherein the autofluorescence is generated by a dichroic mirror disposed between a spinning micro lens array disk and a spinning pinhole disk.

7. The filter of example 6 wherein the dichroic mirror passes collimated laser illumination received through the spinning micro lens array disk and generates autofluorescence from such collimated laser illumination.

8. A method comprising:
receiving sample fluorescence and auto-fluorescence from a system providing the sample fluorescence at a first focal plane;
collimating the rays of received sample fluorescence originating from each point in the sample;
passing the collimated sample fluorescence rays at a point where the centerlines of the rays from each point in the sample converge; and
receiving the passed rays from the spatial filter and forming images at a second focal plane.

9. The method of example 8 wherein the collimated sample fluorescence rays are passed through a pinhole opening having a diameter corresponding to a diameter of a bundle of the collimated rays.

10. The method of any of examples 8-9 wherein the collimated sample fluorescence rays are passed through an adjustable iris, adjustable to a diameter corresponding to a diameter of a bundle of the collimated rays.

11. The method of any of examples 8-10 wherein the first focal plane receives an image of a fluorescing sample, wherein rays of the image are collimated by a first lens to diameter D3, wherein an opening at the convergence of the collimated rays has a diameter of approximately D3, and wherein autofluorescence is received and is dispersed at the first focal plane.

12. The method of example 11 wherein the received autofluorescence is generated by a dichroic mirror and wherein the sample fluorescence is received through a rotating pinhole.

13. The method of example 12 wherein the sample fluorescence and autofluorescence are received from a spinning disk confocal microscopy unit, and wherein the autofluorescence is generated by a dichroic mirror disposed between a spinning micro lens array disk and a spinning pinhole disk.

14. The method of example 13 wherein the dichroic mirror passes collimated laser illumination received through the spinning micro lens array disk and generates autofluorescence from such collimated laser illumination.

The following statements are potential claims that may be converted to claims in a future application. No modification of the following statements should be allowed to affect the interpretation of claims which may be drafted when this provisional application is converted into a regular utility application.

1. A spatial filter comprising:
a first focal plane to receive sample fluorescence and background auto-fluorescence from a microscope;
a first lens to receive the sample fluorescence and background auto-fluorescence and focus the rays of the sample fluorescence;
a spatial filter positioned in a plane where sample fluorescence rays maximally converge, the spatial filter having a mask aperture positioned where such rays converge to pass the rays, the aperture having a size that is a function of characteristics of the microscope; and
a second lens positioned to receive the passed rays from the mask aperture and form images at a second focal plane to couple to a camera.

2. The spatial filter of claim 1 wherein the mask aperture is a circular opening having a diameter corresponding to a diameter of a bundle of the rays of sample fluorescence emanating from a single point in the sample.

3. The spatial filter of claim 1 wherein the mask aperture is an adjustable iris, adjustable to a diameter corresponding to a diameter of a bundle of the rays of sample fluorescence emanating from a single point in the sample.

4. The spatial filter of claim 1 wherein the first focal plane receives an image of a fluorescing sample, wherein rays of the image are focused by the first lens to diameter D3, wherein the mask aperture in the mask has a diameter of approximately D3, and wherein the autofluorescence is blocked by the mask.

5. The spatial filter of claim 1 wherein the received autofluorescence is generated by a dichroic mirror and wherein the sample fluorescence is received through a rotating pinhole array.

6. The spatial filter of claim 1 wherein the sample fluorescence and autofluorescence are provided by a spinning disk confocal microscopy unit, and wherein the autofluorescence is generated by a dichroic mirror disposed between a spinning micro lens array disk and a spinning pinhole disk.

7. The spatial filter of claim 6 wherein the dichroic mirror passes collimated laser illumination received through the spinning micro lens array disk and generates autofluorescence from such collimated laser illumination.

8. A method comprising:
receiving sample fluorescence and auto-fluorescence from a microscope providing the sample fluorescence at a first focal plane;
focusing the received sample fluorescence;
passing the sample fluorescence through a circular aperture having a diameter adapted to pass sample fluorescence at a point where the rays of sample fluorescence maximally converge; and
receiving the passed rays from the spatial filter and forming images at a second focal plane.

9. The method of claim 8 wherein the sample fluorescence is passed through a pinhole opening having a diameter corresponding to a diameter of a bundle of the collimated rays received from a single point in the sample plane of a microscope.

10. The method of claim 8 wherein the sample fluorescence is passed through an adjustable iris, adjustable to a diameter corresponding to a diameter of a bundle of the collimated rays received from a single point in the sample plane of a microscope.

11. The method of claim 8 wherein the first focal plane receives images of fluorescing samples, wherein bundles of rays emanating from a single point in the sample are collimated by a first lens to diameter D3, wherein an opening at the convergence of the bundles of rays has a diameter of approximately D3, and wherein autofluorescence is received and is blocked by a mask in which the opening is formed.

12. The method of claim 11 wherein the received autofluorescence is generated by a dichroic mirror and wherein the sample fluorescence is received through a rotating pinhole array.

13. The method of claim 12 wherein the sample fluorescence and autofluorescence are received from a spinning disk confocal microscopy unit, and wherein the autofluorescence is generated by a dichroic mirror disposed between a spinning micro lens array disk and a spinning pinhole disk.

14. The method of claim 13 wherein the dichroic mirror passes collimated laser illumination received through the spinning micro lens array disk and generates autofluorescence from such collimated laser illumination.
